(19) United States
(12) Patent Application Publication
(10) Pub. No.: US 2022/0308622 A1
(43) Pub. Date: Sep. 29, 2022

(54) ELECTRONIC DEVICE WITH RETRACTABLE SPEAKERS

(71) Applicant: Lenovo (Singapore) Pte. Ltd., New Tech Park (SG)

(72) Inventors: Nathan Hatfield, Raleigh, NC (US); Matthew Manuel Davis, Durham, NC (US)

(21) Appl. No.: 17/209,688

(22) Filed: Mar. 23, 2021

(51) Int. Cl. G06F 1/16; G06F 21/31; H04R 1/02; H04R 3/00

(52) U.S. Cl. CPC G06F 1/1607; G06F 21/31; H04R 1/028; H04R 3/00; H04R 2201/025; H04R 2499/15

(57) ABSTRACT

An electronic device is provided that includes a display subassembly having a display that visually presents information. The electronic device also includes a base subassembly having an input device coupled to the display subassembly to permit movement between the display subassembly and base subassembly. Finally, the electronic device includes a speaker configured to be disposed within the display subassembly and to be movable from a first position within the display subassembly to a second position extending from the display subassembly.

### BACKGROUND

Embodiments of the present disclosure generally relate to electronic devices and more particularly to electronic assemblies with retractable speakers.

A wide variety of electronic devices are offered today. Examples of electronic devices include computers (e.g., laptop or tablet computers), mobile phones, cellular phones, iPhone, smart phones, tablets, iPads, iPods, personal digital assistants (PDAs), smart watches, or the like. As electronic devices become more compact, more functionality and also desired.

Personal computers often suffer from poor audio experiences due to the position or makeup of the native speakers that are part of the base subassembly on the C and/or D covers of the device. For example, native speakers that are on the D cover, or bottom of the base subassembly produce sound that bounces off the surface upon which the personal computer sits before being provided to the user, muffling such sounds.

In addition with personal computers, typically there is little room for the native speakers on the C cover of the device where the keyboard is located. Specifically, often, in addition the keyboard and functional keys, in addition touch pads and actuation buttons are on the C cover. In addition, there is also the area of the C cover where an individual rests their hands when typing. This leaves little open room on the C cover for placing a speaker, resulting in a reduced size of the speaker, or sound having to carry through an object, such as a person's hands, the cover, etc. Meanwhile, the sides of the bases subassembly typically include ports, disc drives, etc., again leaving little room for native speakers. In addition, such native speakers are pointed directionally towards the sides, away from a user. In all, the overall sound quality associated with personal computers can be very poor.

In order to address the quality of sound, increases in volume that can be produced by individual speakers can be increased. To this end, a volume control can be provided to users as well. Still, increases in volume often come with increases in electrical components where such increases are undesirable. In addition, different users of a personal computer may have different sound preferences such that just increasing volume may not be desirable.

### SUMMARY

In accordance with embodiments herein, an electronic device is provided that includes a display subassembly having a display that visually presents information. The electronic device also includes a base subassembly having an input device coupled to the display subassembly to permit movement between the display subassembly and base subassembly. Finally, the electronic device includes a speaker configured to be disposed within the display subassembly and to be movable from a first position within the display subassembly to a second position extending from the display subassembly.

Optionally, the speaker is coupled within the display subassembly when in the second position. In one aspect, the speaker is configured to be detachable from the display subassembly. In another aspect, the speaker is configured to be coupled to the base subassembly. In one example, the base subassembly is configured to receive the speaker such that the speaker is disposed with the base subassembly. In another example, the speaker is pivotably coupled to the display subassembly in the second position and configured to pivot about a pivot point in the second position.

Optionally, the speaker is a first speaker, and the electronic device further comprises a second speaker disposed within the display subassembly and configured to be movable from a first position within the display subassembly to a second position extending from the display subassembly. In one aspect, the electronic device also includes one or more processors, and a data storage device having executable instructions accessible by the one or more processors. Responsive to execution of the instructions, the one or more processors are configured to obtain user characteristics and electronic characteristics, and move the speaker from the first position to the second position based on one of the user characteristics or electronic characteristics. In another aspect, the one or more processors are configured to pivot the speaker in the second position based on one of the user characteristics or electronic characteristics. In one example, the user characteristics include at least one of age of user, permission settings of user, identification of user, or inputs of user. In another example, the electronic characteristics include at least one of application in use, input of user, or position of display subassembly compared to the base subassembly.

In accordance with embodiments herein, an electronic device is provided that may include a display subassembly including a display that visually presents information, and a speaker configured to be disposed within the display subassembly and to be movable from a first position within the display subassembly to a second position extending from the display subassembly.

Optionally, the speaker is pivotably coupled to the display subassembly in the second position and configured to pivot about a pivot point in the second position. In one aspect, the speaker is a first speaker, and the electronic device further comprises a second speaker disposed within the display subassembly and configured to be movable from a first position within the display subassembly to a second position extending from the display subassembly. In another aspect, the electronic device also includes one or more processors, and a data storage device having executable instructions accessible by the one or more processors. Responsive to execution of the instructions, the one or more processors are configured to obtain user characteristics and electronic characteristics, and move the speaker from the first position to the second position based on one of the user characteristics or electronic characteristics. In one example, the one or more processors are configured to pivot the speaker in the second position based on one of the user characteristics or electronic characteristics.

In accordance with embodiments herein, an electronic device is provided that includes a display subassembly including a display that visually presents information, and a base subassembly including an input device coupled to the display subassembly to permit movement between the display subassembly and base subassembly. The electronic device also includes a speaker configured to be disposed within the display subassembly and to be movable from a first position within the display subassembly to a second position extending from the display subassembly. The electronic device also includes one or more processors, and a data storage device having executable instructions accessible by the one or more processors. Responsive to execution of the instructions, the one or more processors are configured to move the speaker from the first position to the second position.

Optionally, the one or more processors are also configured to obtain user characteristics, and move the speaker from the first position to the second position based on the user characteristics. In one aspect, the one or more processors are also configured to obtain electronic device characteristics, and move the speaker from the first position to the second position based on the electronic device characteristics. In another aspect, the electronic device also includes a sensor coupled to the one or more processor, the sensor configured to detect user characteristics.

### BRIEF DESCRIPTION OF THE DRAWINGS

FIG. 1 illustrates a perspective view of an electronic device formed in accordance with an embodiment described herein.

FIG. 2 illustrates a perspective view of an electronic device formed in accordance with an embodiment described herein.

FIG. 3 illustrates a perspective view of an electronic device formed in accordance with an embodiment described herein.

FIG. 4 illustrates a perspective view of an electronic device formed in accordance with an embodiment described herein.

FIG. 5 illustrates a schematic block diagram of a control system for an electronic device in accordance with an embodiment described herein.

FIG. 6 illustrates a block flow diagram of a method of operating speakers of an electronic device in accordance with an embodiment described herein.

### DETAILED DESCRIPTION

It will be readily understood that the components of the embodiments as generally described and illustrated in the figures herein, may be arranged and designed in a wide variety of different configurations in addition to the described example embodiments. Thus, the following more detailed description of the example embodiments, as represented in the figures, is not intended to limit the scope of the embodiments as claimed, but is merely representative of example embodiments.

Reference throughout this specification to “one embodiment” or “an embodiment” (or the like) means that a particular feature, structure, or characteristic described in connection with the embodiment is included in at least one embodiment. Thus, appearances of the phrases “in one embodiment,” “in an embodiment” or the like in various places throughout this specification are not necessarily all referring to the same embodiment.

Furthermore, the described features, structures or characteristics may be combined in any suitable manner in one or more embodiments. In the following description, numerous specific details are provided to give a thorough understanding of the various embodiments. One skilled in the relevant art will recognize, however, that the various embodiments can be practiced without one or more of the specific details, or with other methods, components, materials, etc. In other instances, well-known structures, materials, or operations are not shown or described in detail to avoid obfuscation. The following description is intended only by way of example, and simply illustrates certain example embodiments.

The term “base subassembly” refers to any and all assemblies of an electronic device that do not contain a display. The base subassembly may include an input device such as keys of a keyboard, ports such as USB ports, activation buttons, touch pads, or the like. The base subassembly may include a housing for one or more processors, a storage device, functional circuitry, etc. The base subassembly may be referred to as C/D cover with the C side being the side typically having the keyboard, activation buttons, touch pad, etc., and the D side being opposite of the C side, and typically having legs, pads, etc. for sitting the electronic device on a surface.

The term “display subassembly” refers to any and all assemblies of an electronic device that contain a display. The display subassembly may include a screen, touch screen, camera, bevel, etc. The display subassembly may couple to a base subassembly, including via hinge such that the display subassembly and base subassembly can pivot about a pivot axis. The display subassembly may be detachable from the base subassembly. The display subassembly may also not include a base subassembly, such as a tablet, smartphone, or the like. Instead, all input devices, ports, etc. are part of the display subassembly. The display subassembly may be referred to as an AB cover with the A side typically being the side of the display subassembly that does not contain a display, and opposite the B side that does include the display.

The term “user characteristics” refers to any and all traits, parameters, details, information, data, etc. related to a user of a device. User characteristics include characteristics that are input by a user or other, including profile information, user settings, user passwords, application settings, etc. User characteristics also include characteristics obtained by the electronic device, including electronically through communications, and electronically through sensors. Specifically, user characteristics may be obtained through a network, cloud, server, remote device, etc. User characteristics may also be obtained from a disk, thumb drive, hard drive, memory stick, remote device from a wired connection, remote device from a wireless connection, or the like. User characteristics may also be obtained from sensors, including cameras, microphones, motion sensors, fingerprint scanners, biosensors, etc. User characteristics can include age of user, permission settings of user, identification of user, inputs of user, etc.

The term “electronic characteristics” refers to any and all parameters, details, information, data, etc. related to an electronic device. The electronic characteristics include electronic device settings, information regarding the electronic device in a storage device of the electronic device, information regarding the electronic device in applications of the electronic device, etc. Electronic characteristics may be obtained electronically through communications, and electronically through sensors. Electronic characteristics can include operation states, application operation states, launching of applications, keyboard use, touch screen use, input device use, the angle between a display subassembly and base subassembly, base subassembly temperature, etc.

The term “obtains” and “obtaining”, as used in connection with data, signals, information and the like, include at least one of i) accessing memory of an external device or remote server where the data, signals, information, etc. are stored, ii) receiving the data, signals, information, etc. over a wireless communications link between the base device and a secondary device, and/or iii) receiving the data, signals, information, etc. at a remote server over a network connection. The obtaining operation, when from the perspective of a base device, may include sensing new signals in real time, and/or accessing memory to read stored data, signals, information, etc. from memory within the base device. The obtaining operation, when from the perspective of a secondary device, includes receiving the data, signals, information, etc. at a transceiver of the secondary device where the data, signals, information, etc. are transmitted from a base device and/or a remote server. The obtaining operation may be from the perspective of a remote server, such as when receiving the data, signals, information, etc. at a network interface from a local external device and/or directly from a base device. The remote server may also obtain the data, signals, information, etc. from local memory and/or from other memory, such as within a cloud storage environment and/or from the memory of a personal computer.

It should be clearly understood that the various arrangements and processes broadly described and illustrated with respect to the Figures, and/or one or more individual components or elements of such arrangements and/or one or more process operations associated of such processes, can be employed independently from or together with one or more other components, elements and/or process operations described and illustrated herein. Accordingly, while various arrangements and processes are broadly contemplated, described and illustrated herein, it should be understood that they are provided merely in illustrative and non-restrictive fashion, and furthermore can be regarded as but mere examples of possible working environments in which one or more arrangements or processes may function or operate.

Electronic devices are provided for that allow users to leverage additional speaker panels that are contained within a display subassembly (e.g. AB cover) As an example, the electronic device can include two speakers on opposing sides of the display subassembly. A portion of each speaker is retracted from the side of the display subassembly to allow the user to perform a push interaction. The speakers may also be capable of 1) moving along the y-axis of the display, 2) tilted along the z-axis once expended, or 3) pointed in the opposite direction of the display away from the user. These orientations provide enhanced audio coverage, including directional audio to improve functionality.

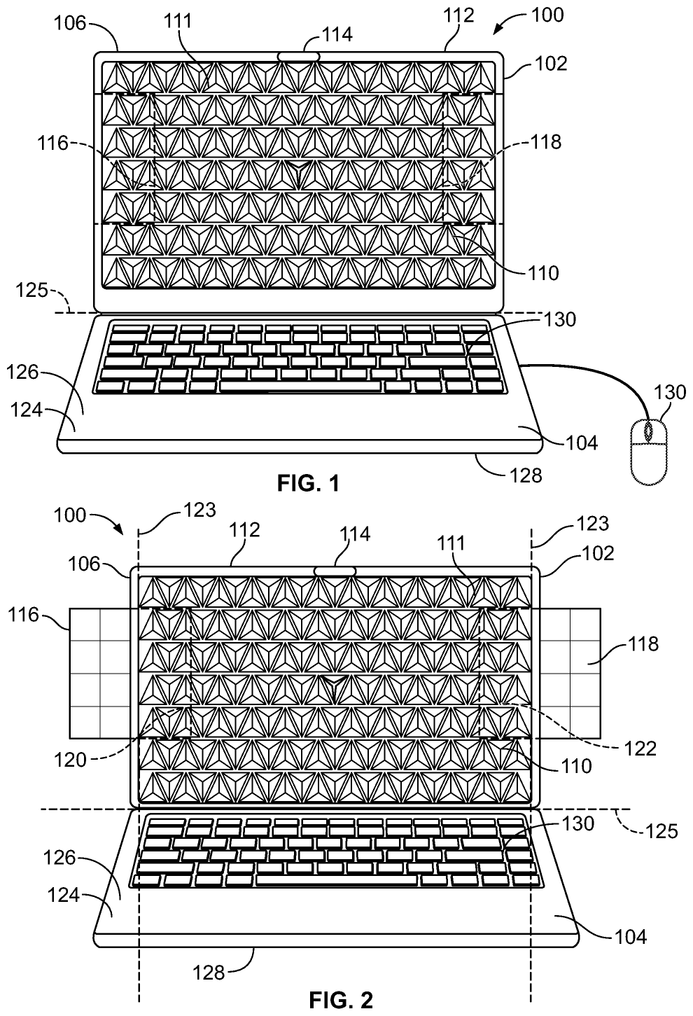

FIG. 1 illustrates a perspective view of an electronic apparatus 100 formed in accordance with an embodiment described herein. The electronic apparatus 100 includes a display subassembly 102 and a base subassembly 104 that are pivotably coupled with each other. The electronic apparatus in example embodiments is a laptop computer, desktop computer, smart phone, personal digital assistant (PDA), tablet, iPad, iPhone, or the like. The display subassembly 102 in one example is a tablet computer or other electronic device that may be detached from the base subassembly.

The display subassembly includes a housing 106 with an outer shell 108 on a first side 109 and a display 110 on an opposite second side 111. The first side 109 is considered the A side, while the second side 111 is considered the B side. The display 110 may be a touchscreen or non-touch sensitive display. The display 110 visually presents information to a user of the electronic apparatus 100 or the display subassembly 102. In one embodiment, adjacent the display 110 on the first side is a bezel 112 that can include one or more sensors 114 such as a camera, motion detector, infrared camera, microphone, or the like. The sensors 114 may be utilized to obtain user characteristics that are used by one or more processor to determine an identification of the individual using the electronic device. For example, a camera may be utilized along with photo identification software to identify a person in from the display. In another example, a microphone with voice recognition software can be used to identify the user. The camera and/or microphone can also be utilized to obtain user characteristics that include the number of individuals viewing the display at one time.

Disposed within the housing 106 of the display subassembly 102 are one or more processors, one or more storage devices, a transceiver, battery, circuitry, etc. Specifically, and components utilized to operate the electronic device 100 is placed within the housing 106 of the display subassembly.

A first speaker 116 and second speaker 118 are also disposed within the housing 106. While in this embodiment two speakers are provided, in other example embodiments only a single speaker is provided. Alternatively three or more speakers may be provided. In one example, the first speaker 116 is disposed inside a first compartment 120, and the second speaker 118 is disposed inside a second compartment 122. In one embodiment, the first compartment 120 and second compartment 122 each include a door covering an opening to the outer environment. In this manner, the first speaker 116, and second speaker are not seen, and do not disrupt the aesthetic appearance of the electronic device. The first and second speakers each move from a first position (FIG. 1) where the speaker is retracted into the display subassembly to a second position (FIG. 2) where the speaker is extended from the display. In one example, each speaker is moved mechanically by a drive system that can include a worm gear, toothed gear, slide, etc. to move the speaker from the first position to the second position. In the example embodiment when a door is provided for the compartment, the door may be mechanically moved to allow the movement of the speaker. In one example, a first actuation input (e.g. button) and second actuation input may be placed on the display subassembly to control the movement of each speaker from the first position to the second position. Alternatively, when the electronic device is in operation, an input may be provided on a touch screen, via an input device such as a keyboard or mouse, etc. to control the movement of each speaker from the first position to the second position using an application.

In another example embodiment, when each compartment does not have a door, each speaker is spring loaded within each compartment such that if a user pushes inwardly on the speaker, the speaker then extends out of the compartment. In one example, the entire speaker extends from the compartment as a result of pushing the speaker inward, whereas alternatively, enough of the speaker extends such that a user can grip or grab the speaker to extend the speaker away from the compartment. Optionally, the housing 106 can include a stop element for each speaker to prevent the speaker from being completely extracted from the display subassembly 102. In an alternative embodiment, each speaker may detach from the display subassembly 102. In this manner, each speaker is configured to be detachable from the display subassembly 102. When detached, the electronic device communicates with the individual speaker through wireless communication and protocols including Wi-Fi, Bluetooth, near-field communication (NFC), or the like.

In yet another embodiment, each speaker partially extends from the compartment. In such embodiments, the speaker may be spring loaded within each compartment such that if a user pushes inwardly on the speaker, the speaker extends out of the compartment. Alternatively, by partially extending from the compartment the speaker may be pinched, or grabbed by a user and manually extended from the compartment. In this embodiment, the housing may also have a stop in the housing 106, or alternatively or additionally can detach from the housing of the display subassembly 102.

In one embodiment, when a speaker is in an extended position the speaker may include an attachment axis 123 that is a pivot axis about which the speaker can rotate in a z-direction. Specifically, the attachment axis may include a hinge, plural hinges, rotatable section, or the like that allows rotation of the speaker to directionally position the speaker to best suit an operator or users. For example, the first speaker 116 and second speaker 118 may be angled toward user to improve sound quality. Alternatively, the first speaker 116 and second speaker 118 may each have individual speaker elements that face towards the user and others that face away from the user. In this manner, for certain applications, when others are listening to the speakers that are not in from the display 110, the speaker may be angled to improve their listening quality. In this manner, additional use and functionality is provided.

The base subassembly 104 includes a housing 124 that couples with the housing 106 of the display subassembly 102. In one example, the display subassembly 102 and the base subassembly 104 are pivotably coupled with each other along a pivot axis 125. Rotation about the pivot axis 125 may occur as the result of an elongated hinge, plural hinges, rotational elements, detachable rotational elements, or the like.

The housing 124 forms at least part of the exterior surface of the base subassembly 104. The housing 124 has a first side 126 and an opposite second side 128. The first side 126 in one example is an input side that includes input devices 130 such as keyboards, touch sensitive surface, actuation buttons, etc. The first side can be considered the C side of the electronic device 100. Meanwhile, the second side 128 is a bottom side of the electronic device that engages a surface when the electronic device is in use. To this end, the second side may have pads, feet, pads, vents, etc. The second side 128 can be considered the D side of the electronic device 100.

In one embodiment, the base subassembly 104 also includes one or more processors, circuitry, etc. in the housing 124. These processors may be similar or identical to the processors in the display subassembly 102. Alternatively, the processors may have more processing capability (e.g., power) relative to the processors. The processors of the display subassembly 102 and/or the processors of the base subassembly 104 may receive signals from the input devices 130 and/or the display 110, and can perform operations based on or use these signals, such as by controlling the information presented on the display 110.

In one embodiment, the housing 124 of the base subassembly 104 defines at least one auxiliary compartment 132 of size and shape to receive the first speaker 116 and/or second speaker 118. To this end, in one example, the auxiliary compartment 132 can contain a third speaker that may be extended from the base subassembly in any of the manners described above in relation to the first speaker 116 and the second speaker 118 from the display subassembly 102. Alternatively, the first speaker 116 or second speaker may be placed in the auxiliary compartment 132 for storage, and held by the housing 124 in place to provide an additional location for placement of the first speaker 116 or second speaker. In particular, in an example, there may be a desire to point either the first speaker 116 or second speaker 118 upward, or toward the display 110. By providing the auxiliary compartment within the housing 124 of the base subassembly 104 such functionality is achieved. Additionally, in one example, two auxiliary compartments can be defined within the housing 124 of the base subassembly 104 each on either side of the housing 124 providing additional directional sound. In particular, when coupled with the first speaker 116 and second speaker 118 that can rotate or pivot about an attachment axis 123, additional directional sound is provided.

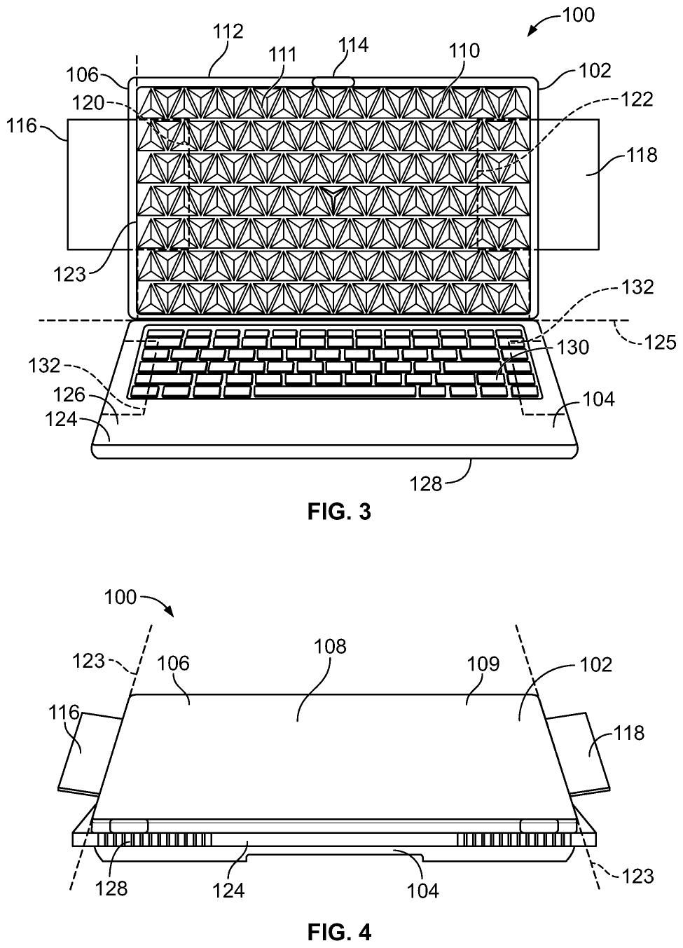

FIGS. 3-4 illustrates an example electronic device 100 in an opened and closed position, respectfully. In the closed position (FIG. 4), the display subassembly 102 engages the base subassembly 104. In this embodiment, the first speaker 116 and second speaker 118 are both in an extended position, and are presented to show the rotation of the first speaker 116 and second speaker 118 about the attachment axis 123. In this example, each attachment axis 123 for both the first speaker 116 and second speaker 118 are defined by a rotatable hinge element. In other example embodiments, other elements may be utilized to provide the attachment axis 123. When in an extended position, each speaker may rotate from a first position (FIG. 3) to a second position (FIG. 4). In this manner, the speaker can be angled toward a user when the electronic device is in an open position, and then rotated toward listeners in a second position. Therefore, even when the electronic device 100 is closed, the electronic device 100 can be used as a speaker system. As a result, in one example, a conference call may be made through the electronic device 100 and the first speaker 116 and second speaker 118 may be directionally angled toward individuals listening to the call.

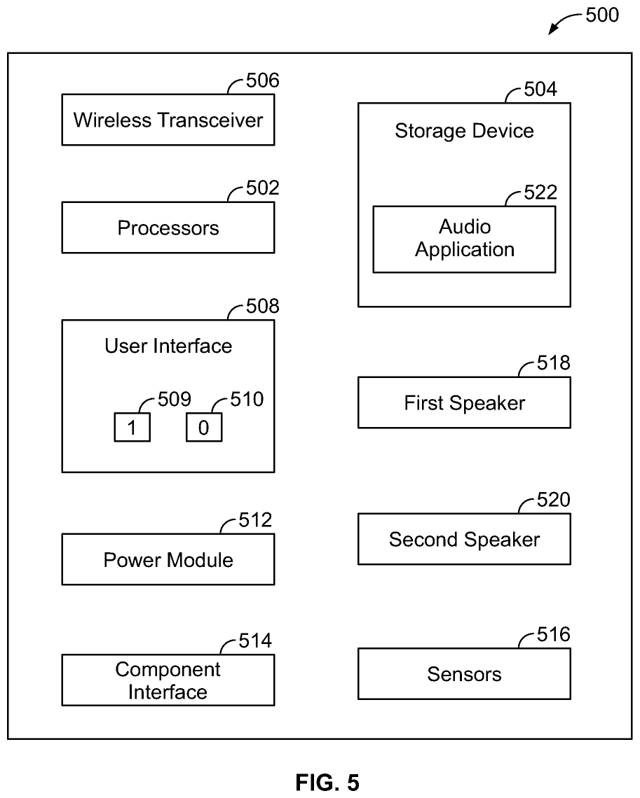

FIG. 5 illustrates a simplified block diagram of a control system 500 for an electronic device. In one example, the electronic device may be any of the electronic devices as described in relation to FIGS. 1-4. To this end, the components of the electronic device may be located only in a display subassembly, only in a base subassembly, or may be located in both the display subassembly and display subassembly.

The control system 500 includes components such as one or more processors 502 (e.g., a microprocessor, microcomputer, application-specific integrated circuit, etc.), one or more local storage medium (also referred to as a memory portion) 504, one or more wireless transceivers 506, a user interface 508 which includes one or more input devices 509 and one or more output devices 510, a power module 512, a component interface 514, one or more sensors 516, a first speaker 518, and a second speaker 520. All of these components can be operatively coupled to one another, and can be in communication with one another, by way of one or more internal communication links, such as an internal bus.

The local storage medium 504 can encompass one or more memory devices of any of a variety of forms (e.g., read only memory, random access memory, static random access memory, dynamic random access memory, etc.) and can be used by the processor 502 to store and retrieve data. The data that is stored by the local storage medium 504 can include, but need not be limited to, operating systems, applications, obtained context data, and informational data. Each operating system includes executable code that controls basic functions of the device, such as interaction among the various components, communication with external devices via the wireless transceivers 506 and/or the component interface 514, and storage and retrieval of applications and context data to and from the local storage medium 506.

The input and output devices 509, 510 may each include a variety of visual, audio, and/or mechanical devices. For example, the input devices 509 can include a visual input device such as an optical sensor or camera, an audio input device such as a microphone, and a mechanical input device such as a keyboard, keypad, selection hard and/or soft buttons, switch, touchpad, touch screen, icons on a touch screen, a touch sensitive areas on a touch sensitive screen and/or any combination thereof. Similarly, the output devices 510 can include a visual output device such as a liquid crystal display screen, one or more light emitting diode indicators, a mechanical output device such as a vibrating mechanism, etc. The display may be touch sensitive to various types of touch and gestures. As further examples, the output device(s) 510 may include a touch sensitive screen, a non-touch sensitive screen, a text-only display, a smart phone display, and/or any combination thereof.

The user interface 508 permits the user to select one or more of a switch, button, or icon to collect context data, and/or enter context data. The user interface 508 can also direct the one or more sensors 516 to obtain user characteristics. As an example, in one embodiment a sensor is a camera and that can take a photo or video (e.g., capture image data). Alternatively, the sensor can be a microphone, motion sensor, global positioning sensor, or the like. Each sensor provides user characteristics that may be utilized by the one or more processors to determine operation of the first speaker 518 and second speaker 520. For example, upon detection of motion in front of the display, the one or more processors may automatically determine to extend the first speaker 518 and second speaker 520 from the display subassembly. Alternatively, a determination is made based on the user characteristics of the individual using the electronic device. For example, a sensor that is a camera may include a facial recognition application that can detect that a teenager that enjoys listing to music is using the electronic device. As a result, the one or more processors extend the first speaker 518 and second speaker 520 from the display subassembly. Meanwhile, if a determination is instead made that a parent is using the electronic device, the speakers 518, 520 are not extended. The one or more processors may make such determination by utilizing an algorithm, mathematical function, mathematical model, lookup table, decision tree, or the like.

In addition, the sensors 516 may also be utilized to obtain electronic device characteristics. For example, a determination can be made whether the electronic device is opened or closed. In addition, electronic device characteristics can also be determined by the one or more processors. For example, determinations can be made related to applications that are in use by the electronic device. For example, if a conference calling application is in use, a music application is in use, a video application is in use, a movie application is in use, or the like, the one or more processors can determine such electronic device characteristics. Then based on the electronic device characteristics, the one or more processor may make determinations related to whether the speakers 518, 520 should be extended.

The local storage medium 506 in one embodiment stores various content including, but not limited to an audio application 522. The audio application 522 includes executable code that utilizes an operating system to provide more specific functionality for the speakers. The audio application 522 may be accessed by a user on the display such that the user can control whether the speakers 518, 520 are in an extended position. Similarly, the use may input user profile inform related to the specific user. In this manner, when the user logs into the electronic device, or alternatively is determined to be using the electronic device, the user may have specific settings for the use of the speaker. For example, a user may choose to have the speakers automatically extend when a conference calling application is in use. In another example, the use may choose to input that when any video is being played, that the speakers should be placed in an extended position. Alternatively, a user may pick and choose which applications cause the extension of the speakers. Such a profile can also include volume level preference. In this manner, the audio application 522 can be used to provide desired operating of the speakers 518, 520 for each individual using an electronic device.

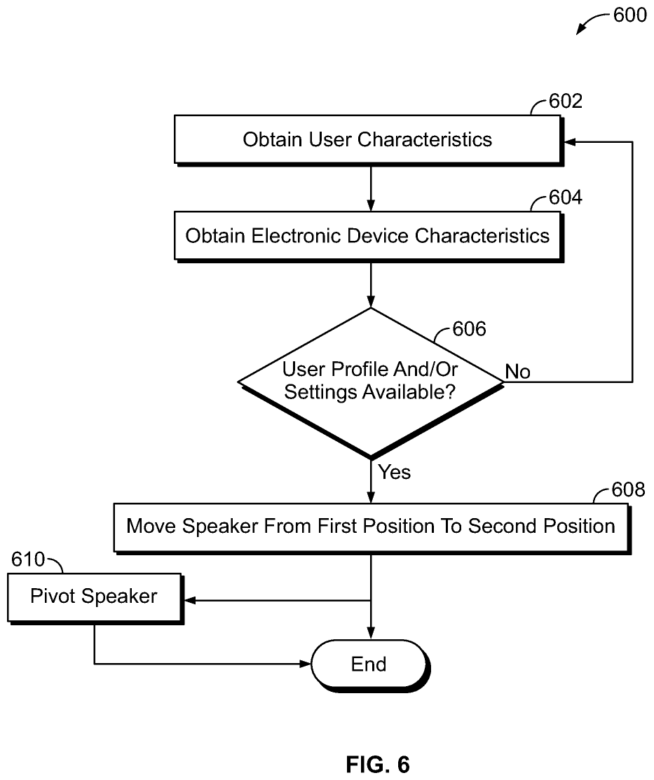

FIG. 6 illustrates a block flow diagram of a method 600 of operating speakers. In one example, an electronic device of FIGS. 1-4 is utilized to implement the method 600. In another example, the control system of FIG. 5 is used to execute instructions to provide the method 600. The electronic device may include a personal computer, laptop computer, tablet, phone, watch, smart device, iPad, iPod, or the like.

At 602, the one or more processors obtain user characteristics. In one example, the user characteristics are obtained via detecting an individual using the electronic device using a sensor such a camera, microphone, motion detector, or the like. To this end, facial recognition, voice recognition, artificial intelligence (AI) modeling, etc. may be used to obtain the user characteristics. In addition, information input into the electronic device may be used to obtain the user characteristic, including the identity of the individual using the electronic device. Such input information includes login information, passwords, application logins and passwords, permission settings, fingerprint scanning, retinal scanning, user profile, user settings, or the like. User characteristics can include the age of a user, permission settings of a user, identification of a user, inputs of a user, or the like. In each instance, the user characteristic obtained provides information related to the identity of the individual using the electronic device.

At 604, the one or more processors obtain electronic device characteristics. In one example, the electronic device characteristics include whether the electronic device is in an opened or closed position, the position of a display subassembly compared to a base subassembly, or the like. In other examples, the electronic device characteristics also include the launching, access, or use of applications, the manual input provided by a user, or the like. For example, the accessing or launching of a video application, music application, calling application, etc. may be the electronic device characteristic. Alternatively, a user actuating a volume input or button can be the electronic device characteristic. Additionally, settings, including volume settings of an electronic device can be the electronic device characteristic. To this end, such a setting may be both a user characteristic and electronic device characteristic.

At 606, the one or more processors determines if a user profile and/or settings are available for the individual using the electronic device and/or the application being used. In particular, based on both user characteristics obtained, and electronic device characteristics obtained, determinations are made regarding the identity of the individual using the electronic device along with applications being utilized by the electronic device. Such determinations may be made using a mathematical model, lookup table, decision tree, algorithm, mathematical function, or the like. If at 606, a determination cannot be made of the availability of a user profile or setting information, then the one or more processors continue to obtain user characteristics and electronic device characteristics.

If at 606, the one or more processors are able to obtain a user profile and/or settings, then at 608, speakers are automatically moved from a first position to a second position based on the user characteristics or electronic characteristics. In one example when the electronic device is a laptop computer used by a family that includes a father and teenage daughter, when the father is identified as using the electronic device, the speakers only move when the father provides an input to actuate the speakers. However, when the daughter is identified as using the electronic device, the speakers may automatically extend from the first position to the second position in response to the identification. In another example, the daughter may have a profile, or setting specific to her during operation of the electronic device. According to the profile speakers may only be desired to be in use when a music application, video application, or phone application are in use, and do not extend until an electronic characteristic indicates that such application has been launched. Alternatively, the settings may include specific webpages, such that when the father opens up a sports based website the speakers extend from the first position to the second position, whereas when the father opens a news based website, the speakers do not extend from the first position to the second position. For this matter, when an application that presents the speakers in the second position is closed, or exited, the speakers can automatically move from the second position back to the first position within the display subassembly. In another example, when the daughter is identified as using the electronic device, the settings may be provided such that from a determined time period, the speakers are not to be in use. So, from 3:00 PM to 7:00 PM Sunday through Thursday the speakers may not be in use because this is a period when the daughter is expected to be doing homework. Then, at 7:00 PM, the speakers may automatically extend from the first position to the second position. Alternatively, after 7:00 PM the speakers may extend from the first position to the second position upon actuation by the user, upon an opening of an application, etc. In each instance, based on user characteristics, electronic device characteristics, or a combination thereof, the speakers automatically move from the first position to the second position.

At 610, optionally, the one or more processors may pivot a speaker in the second position about a pivot axis based on one of the user characteristics and/or electronic characteristics. For example, in one embodiment the one or more processors may detect numerous individuals in an environment of the electronic device as a user characteristic while a conference call application has been launched representing an electronic device characteristic. The one or more processors may then automatically move a speaker from the first position to the second position. Once in the second position, based on the location of individual in the room, the speaker may be pivoted about a pivot access in a z-direction to angle the speaker toward individuals. To this end, if the electronic device is a laptop computer, a user mode may be provided to function as a speakerphone such that the laptop computer is closed, and the speakers pivot about the pivot axis to reach mover individuals with the sound produced by the speaker. In this manner, functionality is improved.

Alternatively, a speaker can be detached from the display subassembly and positioned in the middle of a room by the user. The electronic device may then communicate with the detached speakers via wireless communication and protocols including Wi-Fi, Bluetooth, near-field communication (NFC), or the like. Sound may also be projected out of both sides of the speaker to again increase sound area coverage of the speaker. In another example, if the user is watching a movie with the auxiliary speakers of a base subassembly of an electronic device and then releases the extendable speakers from the display subassembly, the extendable speakers may become active once fixed into position. Moreover, once the extendable speakers are fixed into position, the one or more processors may instantiate a new audio profile that adjusts the purpose of the auxiliary speakers that are part of the base subassembly. The auxiliary speakers, for example, may now serve as a center channel to allow for optimal voice clarity while the extendable speakers promote better bass and fullness of the media content. Conversely, if the extendable speakers are collapsed within the display subassembly, the audio signal routed to the extendable speakers is disconnected. As such, by providing speakers that can be extended from and detached from the display subassembly, enhanced audio quality is achieved.

As will be appreciated by one skilled in the art, various aspects may be embodied as a system, method, or computer (device) program product. Accordingly, aspects may take the form of an entirely hardware embodiment or an embodiment including hardware and software that may all generally be referred to herein as a “circuit,” “module” or “system.” Furthermore, aspects may take the form of a computer (device) program product embodied in one or more computer (device) readable storage medium(s) having computer (device) readable program code embodied thereon.

Any combination of one or more non-signal computer (device) readable medium(s) may be utilized. The non-signal medium may be a storage medium. A storage medium may be, for example, an electronic, magnetic, optical, electromagnetic, infrared, or semiconductor system, apparatus, or device, or any suitable combination of the foregoing. More specific examples of a storage medium would include the following: a portable computer diskette, a hard disk, a random access memory (RAM), a dynamic random access memory (DRAM), a read-only memory (ROM), an erasable programmable read-only memory (EPROM or Flash memory), a portable compact disc read-only memory (CD-ROM), an optical storage device, a magnetic storage device, or any suitable combination of the foregoing.

Program code embodied on a storage medium may be transmitted using any appropriate medium, including but not limited to, wireless, wireline, optical fiber cable, RF, et cetera, or any suitable combination of the foregoing.

Program code for carrying out operations may be written in any combination of one or more programming languages. The program code may execute entirely on a single device, partly on a single device, as a stand-alone software package, partly on single device and partly on another device, or entirely on the other device. In some cases, the devices may be connected through any type of network, including a local area network (LAN) or a wide area network (WAN), or the connection may be made through other devices (for example, through the Internet using an Internet Service Provider) or through a hard wire connection, such as over a USB connection. For example, a server having a first processor, a network interface, and a storage device for storing code may store the program code for carrying out the operations and provide this code through its network interface via a network to a second device having a second processor for execution of the code on the second device.

Aspects are described herein with reference to the figures, which illustrate example methods, devices and program products according to various example embodiments. These program instructions may be provided to a processor of a general purpose computer, special purpose computer, or other programmable data processing device or information handling device to produce a machine, such that the instructions, which execute via a processor of the device implement the functions/acts specified.

The program instructions may also be stored in a device readable medium that can direct a device to function in a particular manner, such that the instructions stored in the device readable medium produce an article of manufacture including instructions which implement the function/act specified. The program instructions may also be loaded onto a device to cause a series of operational steps to be performed on the device to produce a device implemented process such that the instructions which execute on the device provide processes for implementing the functions/acts specified.

Although illustrative example embodiments have been described herein with reference to the accompanying figures, it is to be understood that this description is not limiting and that various other changes and modifications may be affected therein by one skilled in the art without departing from the scope or spirit of the disclosure.

The modules/applications herein may include any processor-based or microprocessor-based system including systems using microcontrollers, reduced instruction set computers (RISC), application specific integrated circuits (ASICs), field-programmable gate arrays (FPGAs), logic circuits, and any other circuit or processor capable of executing the functions described herein. Additionally or alternatively, the modules/controllers herein may represent circuit modules that may be implemented as hardware with associated instructions (for example, software stored on a tangible and non-transitory computer readable storage medium, such as a computer hard drive, ROM, RAM, or the like) that perform the operations described herein. The above examples are exemplary only, and are thus not intended to limit in any way the definition and/or meaning of the term “controller.” The modules/applications herein may execute a set of instructions that are stored in one or more storage elements, in order to process data. The storage elements may also store data or other information as desired or needed. The storage element may be in the form of an information source or a physical memory element within the modules/controllers herein. The set of instructions may include various commands that instruct the modules/applications herein to perform specific operations such as the methods and processes of the various embodiments of the subject matter described herein. The set of instructions may be in the form of a software program. The software may be in various forms such as system software or application software. Further, the software may be in the form of a collection of separate programs or modules, a program module within a larger program or a portion of a program module. The software also may include modular programming in the form of object-oriented programming. The processing of input data by the processing machine may be in response to user commands, or in response to results of previous processing, or in response to a request made by another processing machine.

It is to be understood that the above description is intended to be illustrative, and not restrictive. For example, the above-described embodiments (and/or aspects thereof) may be used in combination with each other. In addition, many modifications may be made to adapt a particular situation or material to the teachings herein without departing from its scope. While the dimensions, types of materials and coatings described herein are intended to define various parameters, they are by no means limiting and are illustrative in nature. Many other embodiments will be apparent to those of skill in the art upon reviewing the above description. The scope of the embodiments should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects or order of execution on their acts.

What is claimed is:

1. An electronic device comprising:
a display subassembly including a display that visually presents information,
a base subassembly including an input device coupled to the display subassembly to permit movement between the display subassembly and base subassembly;
a speaker configured to be disposed within the display subassembly and to be movable from a first position within the display subassembly to a second position extending from the display subassembly; and
one or more processors;
a data storage device having executable instructions accessible by the one or more processors;
wherein, responsive to execution of the instructions, the one or more processors are configured to:
obtain user characteristics or electronic characteristics; and
move the speaker from the first position to the second position based on one of the user characteristics or electronic characteristics.

2. The electronic device of claim 1, wherein the speaker is coupled within the display subassembly when in the second position.

3. The electronic device of claim 1, wherein the speaker is configured to be detachable from the display subassembly.

4. The electronic device of claim 3, wherein the speaker is configured to be coupled to the base subassembly.

5. The electronic device of claim 4, wherein the base subassembly is configured to receive the speaker such that the speaker is disposed with the base subassembly.

6. The electronic device of claim 1, wherein the speaker is pivotably coupled to the display subassembly in the second position and configured to pivot about a pivot point in the second position.

7. The electronic device of claim 1, wherein the speaker is a first speaker, and the electronic device further comprises a second speaker disposed within the display subassembly and configured to be movable from a first position within the display subassembly to a second position extending from the display subassembly.

8. The electronic device of claim 1, wherein the one or more processors are configured to pivot the speaker in the second position based on one of the user characteristics or electronic characteristics.

9. The electronic device of claim 1, wherein the user characteristics include at least one of age of user, permission settings of user, identification of user, or inputs of user.

10. The electronic device of claim 1, wherein the electronic characteristics include at least one of application in use, input of user, or position of display subassembly compared to the base subassembly.

11. An electronic device comprising:
a display subassembly including a display that visually presents information,
a speaker configured to be disposed within the display subassembly and to be movable from a first position within the display subassembly to a second position extending from the display subassembly.

12. The electronic device of claim 11, wherein the speaker is pivotably coupled to the display subassembly in the second position and configured to pivot about a pivot point in the second position.

13. The electronic device of claim 11, wherein the speaker is a first speaker, and the electronic device further comprises a second speaker disposed within the display subassembly and configured to be movable from a first position within the display subassembly to a second position extending from the display subassembly.

14. The electronic device of claim 11, further comprising:
one or more processors;
a data storage device having executable instructions accessible by the one or more processors;
wherein, responsive to execution of the instructions, the one or more processors are configured to:
obtain user characteristics and electronic characteristics; and
move the speaker from the first position to the second position based on one of the user characteristics or electronic characteristics.

15. The electronic device of claim 14, wherein the one or more processors are configured to pivot the speaker in the second position based on one of the user characteristics or electronic characteristics.

16. An electronic device comprising:
a display subassembly including a display that visually presents information,
a base subassembly including an input device coupled to the display subassembly to permit movement between the display subassembly and base subassembly; and
a speaker configured to be disposed within the display subassembly and to be movable from a first position within the display subassembly to a second position extending from the display subassembly.

17. The electronic device of claim 16, further comprising:
one or more processors;
a data storage device having executable instructions accessible by the one or more processors;
wherein, responsive to execution of the instructions, the one or more processors are configured to:
obtain user characteristics; and
move the speaker from the first position to the second position based on the user characteristics.

18. The electronic device of claim 16, further comprising:
one or more processors;
a data storage device having executable instructions accessible by the one or more processors;
wherein, responsive to execution of the instructions, the one or more processors are configured to:
obtain electronic device characteristics; and
move the speaker from the first position to the second position based on the electronic device characteristics.

19. The electronic device of claim 16, further comprising a sensor coupled to the one or more processor, the sensor configured to detect user characteristics.

20. The electronic device of claim 16, wherein in the second position, the speaker extends from the display subassembly.
